(19) United States
(12) Patent Application Publication
(10) Pub. No.: US 2025/0232623 A1
(43) Pub. Date: Jul. 17, 2025

(54) METHOD AND APPARATUS FOR SECURING KEYLESS ENTRY SYSTEM AGAINST RELAY ATTACK

(71) Applicant: Enterprise Electronics LLC, Madison Heights, MI (US)

(72) Inventors: Jeffrey Carl Vogel, Troy, MI (US); Gannon Wheeler, Birmingham, MI (US); Oleksandr Dieiev, Farmington Hills, MI (US); Muhammad Laghari, Southfield, MI (US); Manuel Romera, Sevilla (ES); Vlad Cucos, Isai (RO)

(73) Assignee: Enterprise Electronics LLC, Madison Heights, MI (US)

(21) Appl. No.: 19/011,139

(22) Filed: Jan. 6, 2025

Related U.S. Application Data
(60) Provisional application No. 63/621,797, filed on Jan. 17, 2024.

(51) Int. Cl. G07C 9/00

(52) U.S. Cl. CPC G07C 9/00309; G07C 9/00896; G07C 2009/00587

(57) ABSTRACT

A fob security circuit for a keyless entry system having a fob device and a base unit includes a microprocessor connected to a battery, a transceiver in communication with the microprocessor and the base unit, and a switch. The microprocessor determines when the fob device is in motion and within a predetermined maximum distance of the base unit. The switch is closed when the fob device is in motion within the predetermined maximum distance. This action connects the battery to a communication circuit of the fob device via an enclosure of the fob security circuit. A CLOSED state of the switch connects the battery to the communication circuit. An OPEN state is commanded by the microprocessor when the fob device is not moving within the predetermined maximum distance of the base unit.

### CROSS-REFERENCE TO RELATED APPLICATIONS

The present application claims the benefit of priority to U.S. Provisional Application No. 63/621,797 filed on Jan. 17, 2024, which is hereby incorporated by reference in its entirety for all purposes.

### INTRODUCTION

The present disclosure relates generally to keyless entry systems. More specifically, the present disclosure relates to automated methods and systems for reducing the vulnerability of a key fob or other fob device to a relay attack.

Modern automotive vehicles are frequently equipped with a remote keyless entry (RKE) system. An RKE system allows a user to remotely unlock doors and gain access to the vehicle interior/passenger compartment via a portable key fob, cell phone, or other mobile device, without having to insert a physical key into a corresponding door lock.

In a vehicular RKE system, a portable key fob allows the user to communicate with on-vehicle RKE components when the user wishes to access the vehicle or one or more of its functions when the user is situated outside of the vehicle. Using a typical key fob, the user may remotely unlock the doors or remotely start the vehicle, e.g., to warm up the vehicle interior or engine. The user may also use the key fob to sound the horn or flash the lights when locating the vehicle in a parking lot or executing a panic function. In addition to the key fob, some vehicles also include an externally-mounted alphanumeric keypad that allows the user to gain entry to the vehicle interior by entering a predetermined code.

RKE systems typically operate via a wireless exchange of communication signals that occurs between the key fob and an RKE receiver located onboard the vehicle. This exchange is typically performed via radio frequency (RF) communication or infrared (IR) signals. Remote communication between nodes of a RKE systems is vulnerable to relay attacks, however, whereby a nefarious party may intercept and relay transmitted signals to a separate computer device. In this manner, relay attacks effectively deceive on-vehicle components of the RKE system into believing the key fob is in much closer proximity than it actually is. Relay attacks thus enable unauthorized vehicle access and operation without the attacker ever having custody of the key fob.

### SUMMARY

Disclosed herein are fob-based circuit topologies and corresponding control strategies for preventing relay attacks during operation of a remote keyless entry (RKE) system, e.g., of a motor vehicle, building, garage, or another access-protected enclosure.

As contemplated herein, a fob security circuit includes an electrochemical battery of a key fob or another portable access control device (“fob device”). The fob may be used with a base unit. In some implementations, the base unit may be attached to or hosted onboard the access-protected enclosure, with such an enclosure exemplified herein, solely for the purpose of illustration, as a vehicle interior/passenger compartment of a motor vehicle. A circuit enclosure for the security circuit may have a circular form factor matching that of a typical coin-type fob battery, e.g., a CR2032, CR1616, CR2016, CR2025, or CR2450 cell battery as appreciated in the art, such that the circular enclosure fits on or within an existing circular battery pad of the fob device. In this manner, an existing fob battery may be removed and replaced with the disclosed fob security circuit as an aftermarket solution, or the fob security circuit may be used in lieu of a fob battery during original manufacturing of the fob.

In addition to the above-noted battery, the fob security circuit includes a solid-state switch and a microprocessor. The switch is selectively transitioned to a conducting/ON/CLOSED state by operation of the microprocessor, with the transition decision informed by electronic signals from one or more sensors of the fob security circuit.

The switch otherwise defaults to a non-conducting/OFF/OPEN state. The state transition occurs in response to satisfaction of fob activation criteria. For instance, closure of the switch may be commanded by the microprocessor in response to motion of the fob device within a predetermined distance of the base unit, and/or receipt by the microprocessor of an override signal from an alphanumeric keypad mounted to the access-protected enclosure, or possibly from a cell phone or another suitable input device. Transitioning the switch to the CLOSED state ultimately enables the battery to power a communication circuit of the fob device to thereby enable normal functionality thereof, e.g., remote communication with RKE components of the access-protected enclosure. The communication circuit is therefore not energized unless and until the microprocessor closes the resident switch.

The fob device for use with a base unit, in accordance with one or more representative embodiments, may include a fob housing, a communication circuit, and a fob security circuit connected to the communication circuit and fob housing. The fob security circuit may include a battery, a motion sensor, a microprocessor, and a switch. The motion sensor measures motion of the fob device and generates output signals indicative of the motion. The switch is configured to selectively disconnect the battery from the communication circuit when the switch is in an OPEN state.

The microprocessor in this implementation is operable for transitioning the switch to the OPEN state via an electronic switching control signal when the fob device is not moving relative to the base unit within a predetermined maximum distance of the base unit.

The microprocessor in some embodiments may receive an override signal from an alphanumeric keypad and selectively transition the switch to the CLOSED state in response to the override signal, which may occur regardless of the activation criteria. A circuit enclosure may have a circular form factor, with the fob security circuit being disposed within the circuit enclosure. Embodiments of the fob security circuit may also include a crescent-shaped or arcuate printed circuit board that partially surrounds the battery.

The fob security circuit may include at least one transceiver connected to the microprocessor. The microprocessor may be configured to receive a communication signal from the base unit via the at least one transceiver, determine a time-of-flight of the communication signal between the base unit and the at least one transceiver, e.g., a radio frequency (RF), ultra-wide band (UWB), and/or Bluetooth low energy (BLE) transceiver, and calculate a linear distance between the fob device and the base unit. The distance calculation may be based on the time-of-flight. The microprocessor may selectively transition the switch to the OPEN state when the fob device is not in motion and the linear distance is less than a predetermined maximum distance.

The microprocessor in one or more implementations may also receive a set of user preferences and selectively transition the switch to the CLOSED state in accordance with the user preferences, including a time-of-day setting in a possible approach.

A keyless entry system is also disclosed herein. Embodiments include a base unit connected to an access-protected enclosure. The base unit includes a first microprocessor connectable to a power supply, e.g., a battery or voltage bus, within the access-protected enclosure. A first transceiver is in communication with the first microprocessor. A fob device is in communication with the base unit. The fob device includes a motion sensor operable for detecting motion of the fob device, a communication circuit in remote communication with the first transceiver, and a fob security circuit. The fob security circuit includes a battery, a second microprocessor connected to the battery, a second transceiver, and a switch. The second transceiver is in communication with the first and second microprocessors. The second microprocessor is configured to determine when the fob device is in motion and within a predetermined distance of the base unit, which may be performed in conjunction with the first microprocessor, e.g., using time-of-flight calculations.

The switch in one or more embodiments may be connected to the battery and the second microprocessor. The switch has a CLOSED state in which the battery is connected to the communication circuit to energize the communication circuit. This occurs when the fob device is in motion within the predetermined maximum distance of the base unit. An OPEN state exists in which the battery is disconnected from the communication circuit. This occurs when the fob device is not in motion within the predetermined maximum distance of the base unit.

A method for enabling operation of a fob device is also disclosed herein. Embodiments include determining, via a microprocessor and at least one sensor of a fob security circuit of the fob device, whether certain activation criteria have been satisfied. The fob device includes a communication circuit. When the activation criteria have been satisfied, the method includes commanding a switch of the fob security circuit to transition to a CLOSED state, via the microprocessor, to connect a battery of the fob security circuit to the communication circuit. This selectively enables operation of a fob device. The activation criteria may include the fob device being in motion within a predetermined distance of the base unit.

The method may also include transmitting a communication signal between the fob device and the base unit, calculating a time-of-flight of the communication signal via the microprocessor of the fob device and/or a microprocessor of the base unit, determining a linear distance between the fob device and the base unit using the time-of-flight calculation, and commanding the switch to transition to the CLOSED state via the microprocessor of the fob device when the fob device is moving and the linear distance is within the predetermined maximum distance of the base unit.

The method in one or more implementations also includes receiving an override signal from an alphanumeric keypad via the microprocessor of the fob device. In response, the method includes selectively transitioning the switch to the CLOSED state in response to the override signal, in which case the activation criteria include receipt of the override signal.

The above-described features and advantages and other possible features and advantages of the present disclosure will be apparent from the following detailed description of the best modes for carrying out the disclosure when taken in connection with the accompanying drawings.

### BRIEF DESCRIPTION OF THE DRAWINGS

FIG. 1 is a schematic illustration of a keyless entry system constructed as set forth herein, with the keyless entry system shown as part of a motor vehicle in accordance with a representative use case.

FIG. 2 is a plan view illustration of a representative fob device equipped with a security circuit as set forth herein.

FIGS. 3A and 3B are top and bottom view illustrations of a fob security circuit that is usable as part of the keyless entry system illustrated in FIG. 1.

FIG. 4 is an exploded view illustration of the fob security circuit shown in FIGS. 3A and 3B.

FIG. 5 is a circuit diagram illustrating a possible embodiment of the fob security circuit of FIGS. 3A, 3B, and 4.

FIG. 6 is a circuit diagram illustrating a base unit for use onboard a vehicle or another secured enclosure in conjunction with the security circuit of FIG. 5.

FIG. 7 is a flow chart describing a method for preventing relay attacks in remote keyless entry systems in accordance with the disclosure.

The foregoing and other features of the present disclosure will become more fully apparent from the following description and appended claims when taken in conjunction with the accompanying drawings. The drawings depict several embodiments in accordance with the disclosure and are not to be considered limiting of its scope. The disclosure is described herein with additional specificity and detail through the use of the accompanying drawings. Dimensions disclosed in the drawings or elsewhere herein are not necessarily to scale and are for the purpose of illustration.

### DETAILED DESCRIPTION

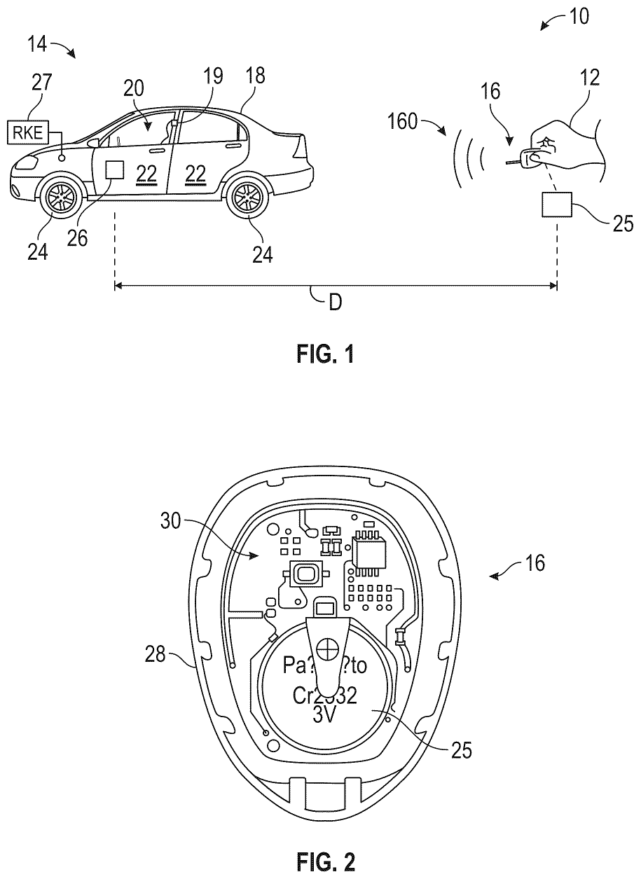

Referring to the drawings, wherein like reference numbers refer to like components, a keyless entry system 10 is illustrated in FIG. 1. In a representative use scenario, a user 12 of a motor vehicle 14 may employ a portable fob device 16 to remotely access or control functions of the motor vehicle 14. The exemplary motor vehicle 14 may include a vehicle body 18 defining a vehicle interior 20, with the vehicle interior 20 being accessible via one or more doors 22. The motor vehicle 14 defines an access-protected enclosure in the representative form of the vehicle interior 20. The motor vehicle 14 also includes a set of road wheels 24 connected to the vehicle body 18, e.g., for a passenger vehicle, truck, engine compartment, or other volume of the motor vehicle 14. Non-vehicular embodiments also may be envisioned within the scope of the disclosure, including but not limited to a garage, residence, or commercial building, as well as remotely operated devices such as lights, sound systems, and the like. Thus, the vehicular use scenario is just one possible implementation of the present teachings.

The fob device 16 as contemplated herein includes a fob security circuit 25, as shown schematically in FIG. 1. The fob security circuit 25, representative embodiments of which are described below with reference to FIGS. 2-4, is placed in remote communication with a base unit 26 in certain implementations. In non-limiting use cases in which the access-protected enclosure includes the vehicle body 18 of FIG. 1, the base unit 26 may be attached to the vehicle body 18 or stowed therewithin. The base unit 26 is used with the fob device 16 to determine a linear distance (D) between the fob device 16 and the base unit 26, with the linear distance (D) being less than a predetermined maximum distance serving as a fob activation criterion. The base unit 26 may be dispensed with in other implementations as set forth below. The motor vehicle 14 also includes a remote keyless entry (RKE) system 27 of a type appreciated in the art, such that the fob device 16, once selectively activated as set forth herein, is able to function in its normal capacity when remotely accessing the motor vehicle 14 and/or operating one or more of its subsystems.

With respect to the RKE system 27, once the fob device 16 is energized, which occurs herein only when predetermined fob activation criteria have been satisfied, an encrypted RF signal 160 may be transmitted in a particular frequency band, e.g., about 300-400 MHz or about 860-950 MHz. Circuit components (not shown) of the RKE system 27 are tuned to the transmission frequency such that when the transmitted encrypted RF signal 160 is ultimately detected by the RKE system 27, the received signal is demodulated and decoded. Certain functions are then enabled or performed when the codes match, e.g., the doors 22 of the motor vehicle 14 may be unlocked, an engine may be started, and/or a horn may be sounded, lights flashed, etc.

### Fob Security Circuit Operation During Relay Attack

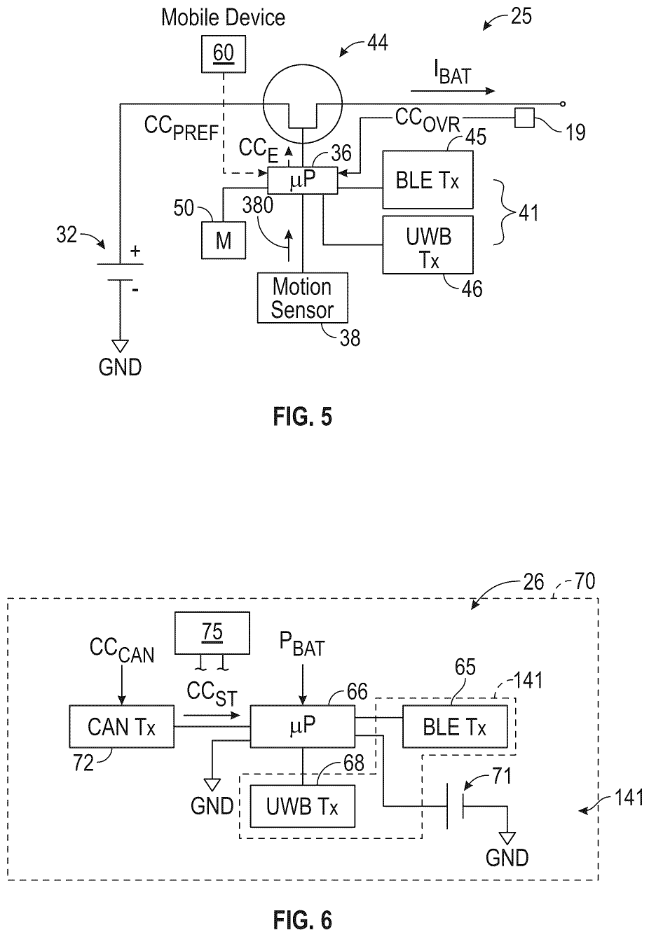

In accordance with the disclosure, the fob security circuit 25 is configured to protect the user 12 against a relay attack of the type summarized above. In contrast with typical button-activated initiation of wireless communication between the fob device 16 and the resident RKE system 27 of the motor vehicle 14, the fob security circuit 25 of the present disclosure first verifies whether fob activation criteria have been satisfied. In a representative embodiment, such criteria may include threshold motion of the fob device 16. Additionally (or alternatively), the fob activation criteria may include the fob device 16 being situated within a predetermined maximum distance of the base unit 26. Either or both conditions may be combined in some implementations with receipt of an override signal (CC_{OVR} of FIG. 5), e.g., from an alphanumeric keypad 19 mounted to the vehicle body 18, or possibly a cell phone (not shown) or another suitable device. The alphanumeric keypad 19 allows the user 12 to leave the fob device 16 in the vehicle interior 20 in a disconnected/inactive state with reduced vulnerability to a relay attack.

Referring briefly to FIG. 2, the fob device 16 includes a fob housing 28 that surrounds the fob security circuit 25 and a resident communication circuit 30, e.g., a radio frequency (RF) or infrared (IR) communication circuit configured to communicate with the RKE system 27 of FIG. 1 when the fob device 16 is energized and performing in a normal operating mode. That is, the fob security circuit 25 selectively energizes the communication circuit 30 to allow communication with the RKE system 27 of the motor vehicle 14 of FIG. 1 to occur.

In one or more embodiments, the fob security circuit 25 may have a circular form factor that matches that of a typical “coin”-style key fob battery, e.g., CR2032, CR1616, CR2016, CR2025, or CR2450, or other typical coin battery sizes. The fob security circuit 25 is therefore usable with existing fob devices 16 simply by removing an existing coin battery therefrom and replacing it with the fob security circuit 25. When the disclosed distance-based security features are also used, communication with the base unit 26 of FIG. 1 or similar hardware and software devices also would be required to complete the requisite exchange of information as described below.

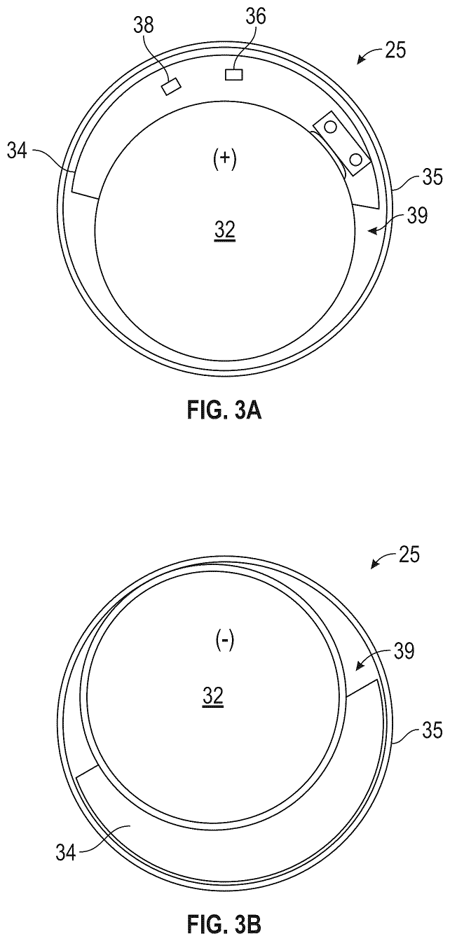

A view of a positive (+) terminal side of the fob security circuit 25 is illustrated in FIG. 3A. A corresponding negative (−) terminal side is presented in FIG. 3B. External buttons (not shown) may be connected to the fob housing 28 of FIG. 2 to allow the user 12 of FIG. 1 to activate the fob device 16 in the typical manner. The fob security circuit 25 of FIG. 3A, which is connected to the communication circuit 30 (FIG. 2) only when the fob activation criteria have been satisfied, includes a cell battery 32 and a resident control board 34. In the illustrated configuration, the control board 34 is a crescent-shaped or arcuate printed circuit board that partially surrounds the cell battery 32. Actual constructions of the control board 34 may take on different shapes, e.g., circular, annular, etc., and therefore the depicted crescent shape of the control board 34 is exemplary and non-limiting.

The fob security circuit 25 of FIGS. 3A and 3B also includes a circuit enclosure 35 that is constructed of steel, copper, or another electrically conductive material. The circuit enclosure 35, e.g., a low-profile cylindrical can defining a cavity 39, has a form factor of a typical fob battery, e.g., CR2032 or another common fob battery such as CR1616, CR2016, CR2025, or CR2450 as noted above. Thus, in an exemplary aftermarket implementation, an existing fob battery may be removed and replaced with the fob security circuit 25 as noted above, or the fob device 16 of FIG. 1 may be manufactured with the fob security circuit 25 already in place.

The control board 34 of FIGS. 3A and 3B includes a microprocessor 36 and a motion sensor 38. The microprocessor 36 is in wired and/or wireless communication with the motion sensor 38 within the circuit enclosure 35. The motion sensor 38, for example a multi-axis accelerometer, is configured to measure motion of the fob device 16. That is, the motion sensor 38 detects when the user 12 of FIG. 1 is actively transporting the fob device 16 or otherwise waving or moving the fob device 16 through free space. Because the microprocessor 36 remains in communication with the motion sensor 38, the microprocessor 36 is updated as to the present motion state and attitude of the fob device 16 on a continuous basis, e.g., once per clock cycle of an oscillator (not shown) of the control board 34, or at another application suitable update frequency. The microprocessor 36 is thus configured to detect threshold motion of the fob device 16 in response to output signals 380 (FIG. 5) from the motion sensor 38. Such motion may be used in one or more embodiments as part of the predetermined fob activation criteria for connecting the cell battery 32 to the communication circuit 30 via the intervening circuit enclosure 35.

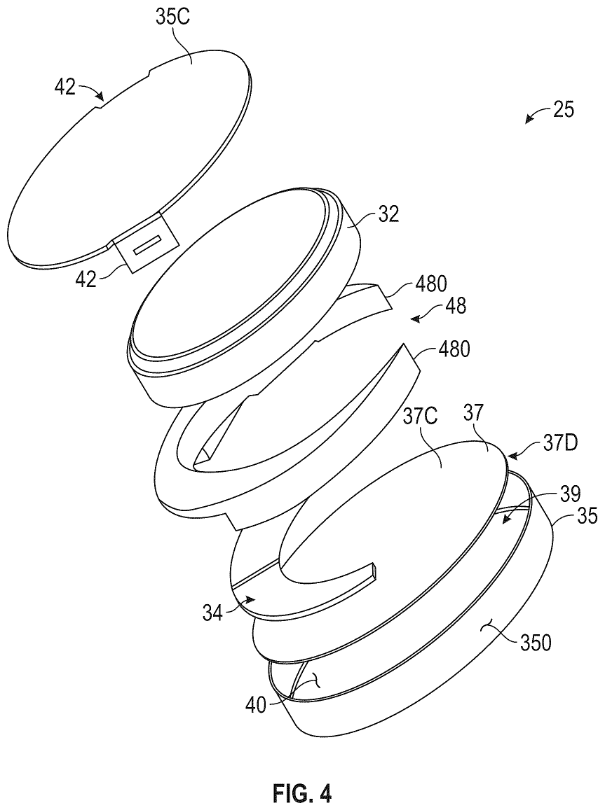

Referring briefly to FIG. 4, an exploded view of the fob security circuit 25 illustrates a possible assembly option in which the circuit enclosure 35 of FIG. 1 includes an outer perimeter wall 350. The outer perimeter wall 350, which likewise has a circular shape, defines the cavity 39. Within the volume of cavity 39, a substrate 37 having an electrically conductive surface 37C and a dielectric surface 37D may rest against a floor 40 of the fob enclosure 35.

In the illustrated construction, a dielectric midframe 48 may be positioned adjacent to the substrate 37 such that the control board 34 is sandwiched or disposed between the substrate 37 and the midframe 48. Distal ends 480 of the dielectric midframe 48 in this non-limiting embodiment in which the dielectric midframe 48 is generally C-shaped, may be gently pried apart to enable the cell battery 32 to be securely grasped around the perimeter of the cell battery 32. A cover 35C is then connected to the circuit enclosure 35, for instance via a pair of negative electrode tabs 42, to thereby encapsulate the cell battery 32 and the control board 34 within the cavity 39. The tabs 42 thus connect a negative terminal of the cell battery 32 within the circuit illustrated in FIG. 5.

Referring now to FIG. 5, a representative implementation of the fob security circuit 25 includes a solid-state switch 44 having a conducting/ON/CLOSED state and a non-conducting/OFF/OPEN state. The switch 44 may be embodied as a normally open/off semiconductor switch, e.g., an insulated-gate bipolar transistor (IGBT) or metal-oxide-semiconductor field-effect transistor (MOSFET), or as a basic transistor switch. The CLOSED/OPEN states of the switch 44 respectively connect/disconnect opposing terminals of the cell battery 32 (shown schematically with its positive (+), negative (−), and ground (GND) connections) to selectively power the communication circuit 30 of FIG. 2, which is located external to the circuit enclosure 35 of FIGS. 3A, 3B, and 4.

Within the fob security circuit 25, the microprocessor (μP) 36 is configured to selectively command the switch 44 to transition to the CLOSED state via an electronic switching control signal (CC_{E}). This control action occurs in response to the activation criteria as noted above, i.e., detected threshold motion of the fob device 16 via the motion sensor 38 and proximity of the fob device 16 to the base unit 26 of FIG. 1, and/or receipt of the override signal (CC_{OVR}) from the alphanumeric keypad 19. The communication circuit 30 of FIG. 2 is therefore not energized by discharge of the cell battery 32 unless and until the microprocessor 36 of FIG. 5 closes the switch 44.

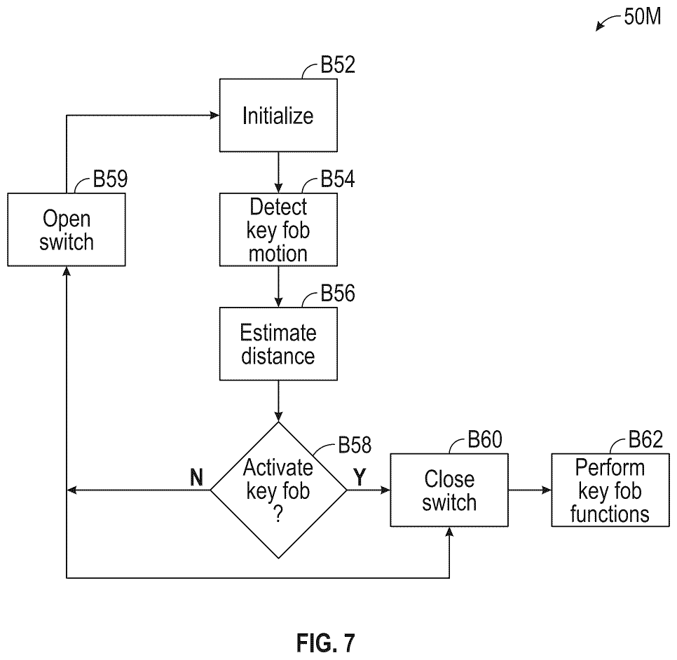

The term “microcontroller” and related terms such as electronic control unit, controller, etc., refer to one or various combinations of Application Specific Integrated Circuit(s) (ASIC), Field-Programmable Gate Array (FPGA), electronic circuit(s), central processing unit(s), and associated transitory and non-transitory memory/storage component(s). The fob security circuit 25 may include a tangible, non-transitory computer storage medium/media (read only, programmable read only, solid-state, random access, optical, magnetic, etc.), with such a computer-readable storage medium shown in FIG. 5 as memory (M) 50 for simplicity. The memory 50, on which computer-readable instructions embodying the method 50M of FIG. 7 may be recorded, is configured to store a machine-readable instruction set in the form of one or more software or firmware programs or routines, combinational logic circuit(s), input/output circuit(s) and devices, signal conditioning and buffer circuitry and other components that can be accessed by one or more processors to provide a described functionality.

Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Ultimately, the microprocessor 36 outputs the electronic switching control signals (CC_{E}) to the switch 44 in the course of performing the method 50M of FIG. 7.

The fob security circuit 25 in the non-limiting configuration of FIG. 5 may include one or more transceivers 41, shown as a representative BLUETOOTH® Low-Energy (BLE) transceiver (Tx) 45 and/or an ultra-wide band (UWB) transceiver (Tx) 46, and possibly other application-suitable transceivers not shown in FIG. 5. That is, distance-based activation of the switch 44 by the microprocessor 36 may be used in conjunction with motion-based activation of the fob device 16 in some embodiments. In a possible implementation, the microprocessor 36 may constantly monitor communication between the BLE transceiver 45 and/or the UWB transceiver 46 and corresponding components of the base unit 26 of FIG. 1. In this manner, the microprocessor 36 remains apprised of the linear distance (D) between the fob device 16 and the base unit 26 as illustrated in FIG. 1. When distance-based activation is not desired, the fob security circuit 25 may forego use of the transceivers 45 and 46.

During optional distance-based embodiments when authorized operation when the fob device 16 is within a predetermined proximity of the base unit 26, e.g., within about 1-2 meters (m) thereof, the switch 44 is transitioned to the CLOSED state by operation of the microprocessor 36. In the CLOSED state, a battery current (I_{BAT}) from the cell battery 32 is conducted through the circuit enclosure 35 to the communication circuit 30 (FIG. 2) to energize the fob device 16 and allow it to function in its normal capacity. However, if the fob device 16 is located too far from the base unit 26 of FIG. 1, regardless of its motion in some implementations, the switch 44 remains in the OPEN/off state. The cell battery 32 therefore remains disconnected and the communication circuit 30 remains offline and unavailable. As a result, the fob device 16 is not vulnerable to relay attacks. When the microprocessor 36 is unable to determine the linear distance (D), or when the linear distance (D) is outside of a defined maximum range, flow of battery power to the communication circuit 30 is likewise prevented.

In one or more embodiments, the user 12 of FIG. 1 or another authorized user of the motor vehicle 14 may configure the keyless entry system 10 to behave in a particular manner. For example, the microprocessor 36 of FIG. 5 may be configured to receive a user preference signal (CC_{PREF}) indicative or descriptive of a set of user preferences, and to selectively transition the switch 44 to the CLOSED state in accordance with the set of user preferences. The user 12 may enable security functions based on a time-of-day setting, e.g., with additional lockout security provided at night, or based on the user's location. The user 12 may also enable access-sharing with family members, friends, or guests in this manner. In a possible implementation, a software application (“app”) may be accessed via a mobile device 60 such as a smart phone or tablet computer, and/or accessed via an available network connection or proprietary connected services.

Referring briefly to FIG. 6, the base unit 26 is be used when distance-based security features are desired. An embodiment of the base unit 26 includes a microprocessor 66. The microprocessor 66 is also referred to herein as a first microprocessor 66 to differentiate from another (second) microprocessor 36 illustrated in FIG. 1). The base unit 26 also includes one or more transceivers 141, e.g., BLE transceiver 65 and/or a UWB transceiver 68 in this embodiment, all of which are contained within a suitable outer enclosure 70. In some implementations, the base unit 26 may include a controller area network (CAN) transceiver (Tx) 72, which in turn may receive CAN bus signals (CC_{CAN}). The state of the CAN bus signals (CC_{CAN}). i.e., CC_{ST}, may be communicated to the microprocessor 66 during operation of the base unit 26, for instance when the CAN bus signals (CC_{CAN}) indicate possible tampering with the base unit 26. In embodiments in which the microprocessor 36 of the fob security circuit 25 of FIG. 5 uses distance detection such as time-of-flight to determine when to close the resident switch 44, the transceiver(s) 141 may communicate with the transceivers 41 (FIG. 5), e.g., the BLE transceiver 45 and/or the UWB transceiver 46, via wireless signal transmission, for example in the 2.4-2.483 GHz band (BLE) or the 3.1 to 10 GHz band (UWB). Thus, the microprocessor 66 may communicate the linear distance (D) to the microprocessor 36 continuously or at calibrated intervals.

The base unit 26 may be powered by a low-voltage auxiliary battery, e.g., nominal 12-15 volt battery, or a low-voltage bus or other available power supply of the motor vehicle 14 of FIG. 1 in some embodiments, with the battery power supply represented by arrow P_{BAT}. The power supply may include an optional resident battery 71 as shown. For convenience, the outer enclosure 70 of the base unit 26 may be designed in such a way that the base unit 26 is able to obtain power, ground connections, and optional vehicle communication capabilities via a standardized connector 75, e.g., J-1962.

Referring to FIG. 7, the method 50M is illustrated as a series of logical process steps or blocks. Each block represents a particular action to be performed by the microprocessor 36 of the fob security circuit 25 (FIG. 5) in conjunction with other associated hardware of the fob device 16. The method 50M is described for a particular embodiment in which the keyless entry system 10 of FIG. 1 is used to control access to the motor vehicle 14. Those skilled in the art will recognize that the method 50M may be implemented in other accessed-controlled stationary or mobile structures, or function-restricted systems such as lighting displays, within the scope of the present disclosure, and therefore the method 50M is not limited to vehicular uses.

In general, the method 50M entails determining, via the first microprocessor 36 and the motion sensor 38 of the fob device 16 of the keyless entry system 10 (FIG. 1), whether the fob device 16 is in motion relative to the base unit 26. When the fob device 16 is in motion relative to a defined range, e.g., non-negligible x, y, and/or z axis motion of a nominal xyz Cartesian reference frame, the method 50M includes commanding the switch 44 of the fob device 16 to close, i.e., to transition to a CLOSED state, with this control action occurring by operation of the first microprocessor 36. The cell battery 32 of the fob device 16 thus energizes the communication circuit to enable normal operational capabilities of the fob device 16. The method 50M in this instance may include transmitting the encrypted RF signal 160 of FIG. 1 to an RKE system 27 located aboard the motor vehicle 14 via the communication circuit 30 while the switch 44 of FIG. 5 is in its CLOSED state.

Beginning with block B52 of FIG. 7, a representative embodiment of the method 50M includes initializing the microprocessor 36 of the fob security circuit 25 shown in FIG. 5. In practice, the fob device 16 remains in a “ready” or “standby” state, so its initialization may not entail the performance of any particular actions after the microprocessor 36 is first placed in service. Periodically, the microprocessor 36 may refresh to clear its resident buffers or otherwise ready itself for use. The method 50M then proceeds to block B54.

Block B54 entails detecting motion of the fob device 16. As part of block B54, the motion sensor 38 (FIG. 5) may monitor multi-axis motion of the fob device 16 to ascertain whether the fob device 16 is being actively carried, waved, or otherwise moved through free space. As appreciated in the art, the motion sensor 38 may be optionally embodied as an accelerometer that outputs nominal x, y, and z acceleration values in the above-noted representative xyz Cartesian reference frame. The microprocessor 36 may receive such values, compare them to non-negligible reference values, and register in its logic that motion exists when any or all of the reference values are exceeded by current readings. The method 50M thereafter proceeds to block B56.

At optional block B56 of FIG. 7, the microprocessor 36 of the fob security circuit 25 (FIG. 5) may also determine a distance of separation of the fob device 16 relative to the base unit 26. Such a distance is represented by the linear distance (D) of FIG. 1. In a possible implementation, two-way communication may be performed by the base unit 26 and the fob device 16 using the UWB transceivers 46 and 68 and/or the BLE transceivers 45 and 65 of FIGS. 5 and 6. For instance, the microprocessor 36 may calculate a time-of-flight (ToF) of an RF pulse communicated between the fob device 16 and the base unit 26, in either direction. By multiplying the ToF by the speed of light, the microprocessor 36 is able to determine the linear distance (D) to a high degree of accuracy. The method 50M then proceeds to block B58 after the linear distance (D) has been ascertained.

At block B58, the microprocessor 36 next determines whether the combination of motion of the fob device 16 (block B54) and the linear distance (D) determined in block B56 warrant activation of the fob device 16. Block B58 may entail comparing the linear distance (D) from block B56 to a predetermined maximum distance to determine if the fob device 16 is within the predetermined maximum distance of the base unit 26. If activation is warranted, the method 50M proceeds to block B59, with the method 50M proceeding in the alternative to block B60.

Block B59 includes commanding the switch 44 of FIG. 4 to transition to an OPEN state. When the switch 44 is embodied as an IGBT, for instance, the microprocessor 36 may apply a voltage of 0 volts or a slightly negative voltage across the gate and emitter to cause the switch 44 to turn off. The OPEN state of the switch 44 effectively disconnects the cell battery 32 from the communication circuit 30 of FIG. 2, thus preventing normal use of the fob device 16. As a result, nefarious actors are unable to intercept signals from the fob device 16 for use in a relay attack. The method 50M then returns to block B52.

Block B60 includes transitioning the switch 44 of FIG. 4 to a CLOSED state, i.e., an on/conducting state. When the switch 44 is embodied as the exemplary IGBT of block B59, for instance, the microprocessor 36 may apply a positive voltage across the gate and emitter to cause the switch 44 to turn on. The CLOSED state of the switch 44 effectively enables the cell battery 32 to energize the communication circuit 30 of FIG. 2, thus allowing use of the fob device 16 in its normal capacity. The method 50M then proceeds to block B62.

At block B62, the fob device 16 is used in its normal capacity to perform its associated fob functions via established two-way communication with an RKE system (not shown) hosted by the motor vehicle 14. Functions may include requesting unlocking or locking of the doors 22, for instance, or starting an engine, heater, air conditioning, defrosters, or other systems of the motor vehicle 14. The method 50M then returns to block B52.

The disclosed solutions help prevent range-extension, amplification, or other relay attacks involving the fob device 16 via a package that fits the form factor of a typical fob battery. Such attacks present a significant vulnerability due to the possibility that RF, IR, or other remote signals transmitted by the fob device 16 could be intercepted and relayed, thus causing the fob device 16 to appear to be in much closer proximity that it actually is. Because in some embodiments the microprocessor 36 of the fob device 16 is configured to selectively transition the switch 44 to the CLOSED state only when the fob device 16 is in motion, and possibly when the linear distance (D) is also less than a predetermined maximum distance of the base unit 26, the attempted relay attack is thwarted. This action prevents unauthorized access to and operation of the motor vehicle 14. Use of the optional keypad 19 of FIG. 1 (or a cell phone or another portable device) would help ensure user access to the motor vehicle 14 when the user 12 is located outside of the motor vehicle 14 and the fob device 16 is located within the motor vehicle 14. These and other attendant benefits will be readily appreciated by those skilled in the art in view of the foregoing disclosure.

Embodiments of the present disclosure are described herein. It is to be understood, however, that the disclosed embodiments are merely examples and other embodiments can take various and alternative forms. The Figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure.

Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

We claim:

1. A fob device for use with a base unit, comprising:
a fob housing;
a communication circuit; and
a fob security circuit connected to the communication circuit and connected to the fob housing, the fob security circuit including:
a battery;
a motion sensor configured to measure motion of the fob device and generate output signals indicative of the motion of the fob device;
a microprocessor in communication with the motion sensor, the microprocessor being configured to detect a threshold motion of the fob device in response to the output signals from the motion sensor; and
a switch configured to selectively connect the battery to the communication circuit when the switch is in a CLOSED state, and to connect the battery to the communication circuit when the switch is in an OPEN state,
wherein the microprocessor is configured to determine, as activation criteria, whether the fob device is (i) in motion relative to the base unit, and (ii) within a predetermined maximum distance of the base unit, and to transition the switch from the OPEN state to the CLOSED state in response to satisfaction of the activation criteria.

2. The fob device of claim 1, wherein the microprocessor is configured to:
receive an override signal from an alphanumeric keypad; and
selectively transition the switch to the CLOSED state in response to the override signal.

3. The fob device of claim 1, further comprising:
a circuit enclosure having a circular form factor, wherein the fob security circuit is disposed within the circuit enclosure, and wherein the fob security circuit includes a crescent-shaped or arcuate printed circuit board that partially surrounds the battery.

4. The fob device of claim 1, wherein the fob security circuit includes at least one transceiver connected to the microprocessor, and wherein the microprocessor is configured to:
receive a communication signal from the base unit via the at least one transceiver;
determine a time-of-flight of the communication signal between the base unit and the at least one transceiver; and
calculate a linear distance between the fob device and the base unit based on the time-of-flight, as the predetermined maximum distance, wherein the microprocessor is configured to selectively transition the switch to the CLOSED state when the fob device is in motion and the linear distance is less than the predetermined maximum distance.

5. The fob device of claim 4, wherein the at least one transceiver includes at least one radio frequency (RF) transceiver.

6. The fob device of claim 5, wherein the RF transceiver includes an ultra-wide band (UWB) transceiver and/or a Bluetooth low energy (BLE) transceiver.

7. The fob device of claim 1, wherein the microprocessor is configured to:
receive a set of user preferences, including a time-of-day setting; and
selectively transition the switch to the CLOSED state in accordance with the set of user preferences, the set of user preferences.

8. A keyless entry system, comprising:
a base unit connected to an access-protected enclosure, the base unit including:
a first microprocessor connectable to a power supply within the access-protected enclosure; and
a first transceiver in communication with the first microprocessor; and
a fob device in communication with the base unit, including:
a motion sensor operable for detecting motion of the fob device relative to the base unit;
a communication circuit in remote communication with the first transceiver; and
a fob security circuit including:
a battery;
a second microprocessor connected to the battery;
a second transceiver in communication with the first transceiver and the second microprocessor, the second microprocessor being configured to determine when the fob device is in motion and within a predetermined maximum distance of the base unit; and
a switch connected to the battery and the second microprocessor, the switch having a CLOSED state in which the battery is connected to the communication circuit to energize the communication circuit when the fob device is in motion within the predetermined maximum distance of the base unit, and an OPEN state in which the battery is disconnected from the communication circuit when the fob device is not in motion within the predetermined maximum distance of the base unit.

9. The keyless entry system of claim 8, wherein the access-protected enclosure is a vehicle body of a motor vehicle having a low-voltage battery or a low-voltage bus as the power supply.

10. The keyless entry system of claim 8, wherein the fob security circuit includes a crescent-shaped or arcuate printed circuit board that partially surrounds the battery.

11. The keyless entry system of claim 8, further comprising:
a circular circuit enclosure surrounding the battery, the second microprocessor, the second transceiver, and the switch, wherein a form factor of the circular circuit enclosure is configured to fit on or within a battery pad of the fob device.

12. The keyless entry system of claim 8, wherein the first transceiver and the second transceiver each include a respective Bluetooth low energy (BLE) transceiver and/or a respective ultra-wide band (UWB) transceiver.

13. The keyless entry system of claim 12, wherein the access-protected enclosure is connected to an alphanumeric keypad, and wherein the second microprocessor is configured to:
receive an override signal from the alphanumeric keypad; and
selectively transition the switch to the CLOSED state in response to the override signal.

14. The keyless entry system of claim 8, wherein the second microprocessor is configured to determine when the fob device is within the predetermined maximum distance of the base unit by calculating a time-of-flight of a communication signal that is communicated between the base unit and the fob device via the first transceiver and the second transceiver.

15. The keyless entry system of claim 8, wherein motion sensor includes a multi-axis accelerometer.

16. The keyless entry system of claim 8, wherein the base unit is configured to connect to a vehicle body of a motor vehicle.

17. The keyless entry system of claim 8, wherein the second microprocessor is configured to:
receive a user preference signal from a mobile device, the user preference signal being indicative of one or more user preferences; and
selectively control operation of the switch in response to the user preference signal.

18. A method for enabling operation of a fob device, comprising:
determining, via a microprocessor and at least one sensor of a fob security circuit of the fob device, whether activation criteria have been satisfied, the fob device including a communication circuit, wherein the activation criteria include (i) motion of the fob device relative to a base unit, and (ii) the fob device being within a predetermined maximum distance of the base unit; and when the activation criteria have been satisfied, commanding a switch of the fob security circuit to transition to CLOSED state, via the microprocessor, to thereby connect a battery of the fob security circuit to the communication circuit, thereby selectively enabling the operation of a fob device.

19. The method of claim 18, further comprising:
transmitting a communication signal between the fob device and the base unit;
calculating a time-of-flight of the communication signal via the microprocessor of the fob device and/or a microprocessor of the base unit;
determining a linear distance between the fob device and the base unit using the time-of-flight; and
comparing the linear distance to the predetermined maximum distance to determine if the fob device is within the predetermined maximum distance of the base unit.

20. The method of claim 18, further comprising:
receiving an override signal from an alphanumeric keypad via the microprocessor of the fob device; and
selectively transitioning the switch to the CLOSED state in response to the override signal, wherein the activation criteria include receipt of the override signal.
